(19) United States
(12) Patent Application Publication
(10) Pub. No.: US 2009/0201452 A1
(43) Pub. Date: Aug. 13, 2009

(54) LIQUID CRYSTAL COMPOSITION AND DISPLAY DEVICE HAVING THE SAME

(76) Inventors: Sungmin Kang, Seoul (KR); Seung-Ju Lee, Gwangmyeong-si (KR); Yun Jang, Suwon-si (KR); Yeon-Sik Ham, Suwon-si (KR); Seung-Hee Lee, Seoul (KR); Hee-Wook Do, Cheonan-si (KR); Myeong-Ha Kye, Seoul (KR)

Correspondence Address: Haynes and Boone, LLP;IP Section, 2323 Victory Avenue, SUITE 700, Dallas, TX, 75219, US

(21) Appl. No.: 12/368,198

(22) Filed: Feb. 9, 2009

(30) Foreign Application Priority Data
Feb. 11, 2008 (KR) 10-2008-0012307

(51) Int. Cl. G02F 1/1337; C09K 19/00; C09K 19/34; C09K 19/06

(52) U.S. Cl. 349/127; 252/299.01; 252/299.61; 252/299.6

(57) ABSTRACT

The present invention relates to liquid crystal composition and a display device having the same. The liquid crystal composition includes uniaxial liquid crystal molecules and biaxial liquid crystal molecules mixed with the uniaxial liquid crystal molecules for controlling an alignment direction of the uniaxial liquid crystal molecules. The liquid crystal composition helps reduce generation of singular points and texture regions where orientation of liquid crystal molecules are difficult to control. Hence, the liquid crystal composition is able to provide improved image quality.

### CROSS-REFERENCE TO RELATED APPLICATION

This application claims priority to and the benefit of Korean Patent Application No. 10-2008-0012307 filed in the Korean Intellectual Property Office on Feb. 11, 2008, the entire content of which is incorporated herein by reference.

### BACKGROUND OF THE INVENTION

(a) Field of the Invention

The present invention relates to liquid crystal composition and a display device having the same.

(b) Description of the Related Art

There are various types of display devices today. Due to the rapid developments in semiconductor technology, liquid crystal display (LCD), in particular, has seen significant reduction in size and weight and performance improvement. Hence, liquid crystal display has been receiving much attention as a mainstream display device.

However, liquid crystal display has its drawbacks, one of which is a narrow viewing angle. In order to overcome this drawback, a vertically aligned (VA) mode liquid crystal display has been introduced. The VA mode liquid crystal display has a multiple domain structure where one pixel is divided into a plurality of domains to improve display characteristics and to realize a wide optical viewing angle. A pixel is a minimum unit for displaying an image. In VA mode, a longitudinal axis of a liquid crystal molecule is aligned orthogonally to the substrates in the absence of an electric field. That is, in the VA mode liquid crystal display, liquid crystal molecules having a negative dielectric constant switch their orientations from vertical alignment to horizontal alignment when an electric field is applied. The horizontally aligned liquid crystal molecules transmit light by double refraction.

Further, various methods are used to drive each liquid crystal molecule to have a different pretilt direction at each of the domains. As a method for inducing different pretilt directions, a patterned vertically aligned (PVA) mode has been introduced. The PVA mode induces pretilt directions of liquid crystal molecules using a fringe field that is generated by an incision pattern formed at an electrode and a pixel electrode when an electric field is applied.

However, the VA mode liquid crystal display disadvantageously has a region where the pretilt direction of liquid crystal molecule cannot be controlled because liquid crystal molecules induced to have different pretilt directions at each domain collide and interfere with each other or because an unintended force influences the liquid crystal molecules. As described above, a point where liquid crystal molecules collide is referred to as a singular point. A region around the singular point where liquid crystal molecules are not controlled is referred to as a “texture region.” In the texture region, light transmittance deteriorates and response speed of liquid crystal modules is reduced. Therefore, image quality of a liquid crystal display becomes compromised.

In order to overcome such a problem, a plurality of notches are disposed along an incision pattern formed at a pixel electrode and a common electrode for controlling a position where a singular point is generated. That is, an attempt to minimize the deterioration of light transmittance by controlling the position of a singular point through the notches has been attempted.

However, the singular point cannot be perfectly controlled according to the number and positions of notches, and some generated singular points cannot be controlled through notches. Therefore, the forming of notches formed along the incision pattern is not a perfect solution to the problems caused by a singular point.

The above information disclosed in this Background section is only for enhancement of understanding of the background of the invention and therefore it may contain information that does not form the prior art that is already known in this country to a person of ordinary skill in the art.

### SUMMARY OF THE INVENTION

An exemplary embodiment of the present invention provides liquid crystal composition including uniaxial liquid crystal molecules, and biaxial liquid crystal molecules mixed with the uniaxial liquid crystal molecules for controlling an alignment direction of the uniaxial liquid crystal molecules.

The uniaxial liquid crystal molecule may include a central functional group, a pair of side functional groups connected to the central functional group, and a pair of end functional groups connected to the pair of side functional groups, respectively. The central functional group may include at least one of the structures expressed by Chemical Structures 1 to 3.

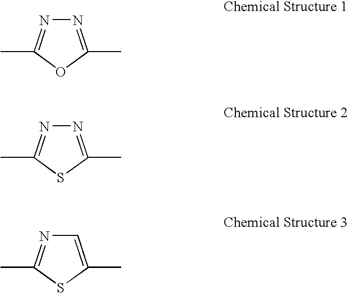

At least one of the side functional groups may include at least one of the structures expressed by the following Chemical Structures 4 to 8. The side functional groups may include the same structure as each other or different structures.

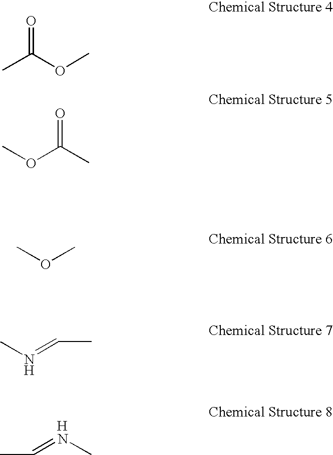

At least one of the end functional groups may include at least one of the structures expressed by Chemical Structures 9 to 12. The end functional groups may include the same structure as each other or different structures.

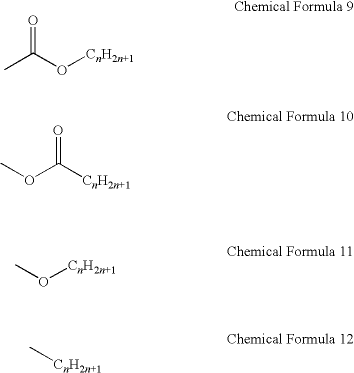

Here, n may be an integer from 2 to 20.

0.1 moles to 1 mole of the biaxial liquid crystal molecules may be mixed with every 1 mole of the uniaxial liquid crystal molecule. Another exemplary embodiment of the present invention provides a display device including a first substrate having a first electrode, a second substrate having a second electrode, and a liquid crystal composition having liquid crystal molecules aligned orthogonally to and between the first substrate and the second substrate when an electric field is applied. The liquid crystal composition includes uniaxial liquid crystal molecules, and biaxial liquid crystal molecules mixed with the uniaxial liquid crystal molecules for controlling an alignment direction of the uniaxial liquid crystal molecules.

Incision patterns may be formed at the first electrode and the second electrode, respectively.

The biaxial liquid crystal molecule may include a central functional group, a pair of side functional groups connected to the central functional group, and a pair of end functional groups connected to the pair of side functional groups, respectively. The central functional group may include at least one of the structures expressed by Chemical Structures 1 to 3.

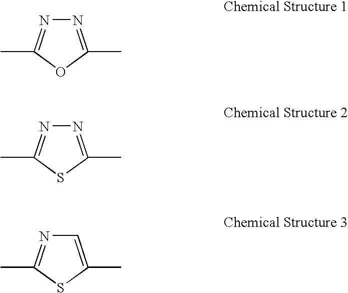

At least one of the pair of side functional groups may include at least one of the structures expressed by following Chemical Formulas 4 to 8, and the pair of side functional groups may include the same structure as each other or different structures.

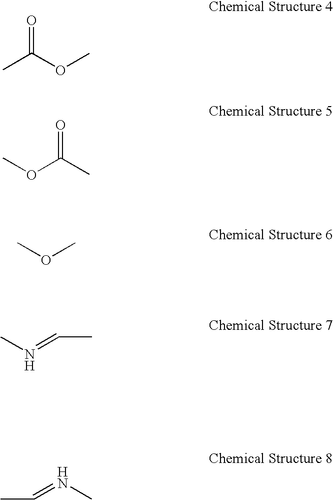

At least one of the end functional groups may include at least one of the structures expressed by Chemical Structures 9 to 12, and the end functional groups may include the same structure as each other or different structures.

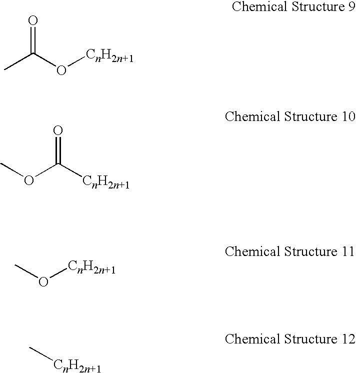

Here, n may be an integer from 2 to 20.

0.1 moles to 1 mole of the biaxial liquid crystal molecules may be mixed with every 1 mole of the uniaxial liquid crystal molecule.

### BRIEF DESCRIPTION OF THE DRAWINGS

FIG. 1 is a perspective view of liquid crystal molecules included in a liquid crystal composition according to an exemplary embodiment of the present invention.

FIG. 2 is a perspective view and a top plan view of movements of liquid crystal molecules of FIG. 1 according to whether an electric field is applied or not.

FIG. 3 is a schematic diagram illustrating biaxial crystal liquid crystal molecules of FIG. 1.

FIG. 4 is a layout view of a display device according to an exemplary embodiment of the present invention.

FIG. 5 is a cross-sectional view of FIG. 4 taken along the line V-V.

FIG. 6 and FIG. 7 are top plane views illustrating distribution of liquid crystal molecules according to an experimental example and a comparative example of the present invention, respectively.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In the accompanying drawings, a display device having an amorphous silicon (a-Si) thin film transistor (TFT) formed through five mask processes is schematically shown as an exemplary embodiment of the present invention. As those skilled in the art would realize, the described embodiments may be modified in various different ways, all without departing from the spirit or scope of the present invention.

Also, a patterned vertically aligned (PVA) mode display device is shown in the accompanying drawings. In the PVA mode display device, one pixel is divided into a plurality of domains. A pixel denotes a minimum unit for displaying an image.

Throughout the specification, for the purpose of clarity, parts that are not relevant to the deend functional grouped description of the present invention will be omitted, and the same reference numerals will be used for like or equivalent constituent elements.

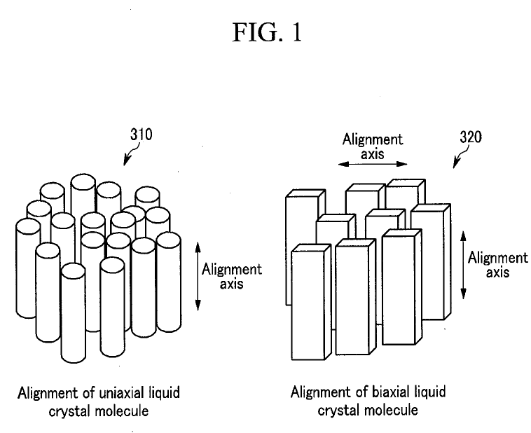

A liquid crystal composition according to an exemplary embodiment of the present invention will now be described with reference to FIG. 1 to FIG. 3.

FIG. 1 is a diagram illustrating liquid crystal molecules 310 and 320 in a liquid crystal composition.

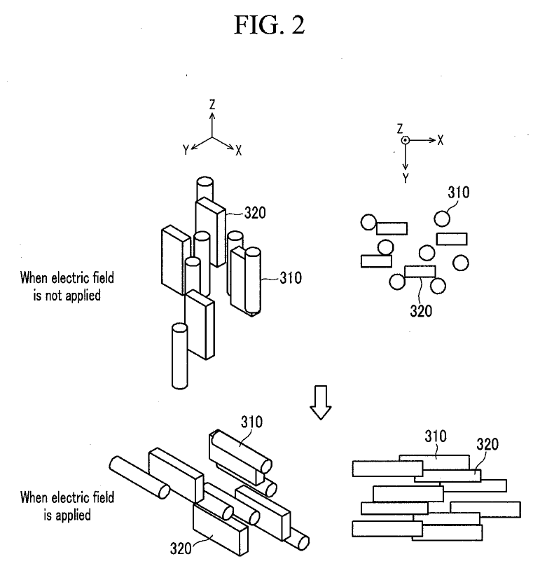

As shown in FIG. 1, the liquid crystal composition includes uniaxial liquid crystal molecules 310 and biaxial liquid crystal molecules 320 mixed with the uniaxial liquid crystal molecules 310 for controlling an alignment direction of the uniaxial liquid crystal molecules 310. FIG. 1 shows alignment axes of the uniaxial liquid crystal molecules 310 and biaxial liquid crystal molecules 320. FIG. 2 shows a mixture of uniaxial liquid crystal molecules 310 and biaxial liquid crystal molecules 320.

The molar ratio of the uniaxial liquid crystal molecules 310 to the biaxial liquid crystal molecules 320 included in the liquid crystal composition is in a range from 1:1 to 1:0.1. That is, every 1 mole of uniaxial liquid crystal molecules 310 is mixed with about 0.1 moles to about 1 mole of biaxial liquid crystal molecules 320. Preferably, the biaxial liquid crystal molecules 320 are mixed in the liquid crystal composition in a predetermined amount that is sufficient for controlling the movement of the uniaxial liquid crystal molecules 310.

The uniaxial liquid crystal molecules 310 are controlled according to the movement of the biaxial liquid crystal molecules 320 as the biaxial liquid crystal molecules 320 are mixed with the uniaxial liquid crystal molecules 310. That is, the uniaxial liquid crystal molecules 310 may have movement similar to that of the biaxial liquid crystal molecules 320.

FIG. 2 shows movements of the uniaxial liquid crystal molecules 310 and the biaxial liquid crystal molecules 320.

The uniaxial liquid crystal molecules 310 and the biaxial liquid crystal molecules 320 are vertically aligned liquid crystal molecules. The vertically aligned liquid crystal molecules generally have a negative dielectric constant. When an electric field is not applied, the vertically aligned liquid crystal molecules are vertically aligned in a direction that crosses a plane surface of a positive electrode forming an electric field. When the electric field is applied, the vertically aligned liquid crystal molecules are aligned horizontally. That is, the vertically aligned liquid crystal molecules are aligned from a vertical state to a horizontal state if an electric field is applied because the dielectric anisotropy is negative. The horizontally aligned liquid crystal molecules transmit light by generating double refraction. Here, “horizontal state” refers to a direction that is non-parallel (e.g., perpendicular) to the electric field, and “vertical state” refers to a direction substantially parallel to the direction of the electric field at the specific position.

Therefore, the uniaxial liquid crystal molecules 310 and the biaxial liquid crystal molecules 320 are aligned in the vertical state (Z-axis direction) when an electric field is not applied. Or, the uniaxial liquid crystal molecules 310 and the biaxial liquid crystal molecules 320 are aligned in the horizontal state (X-axis direction) when an electric field is applied, as shown in FIG. 2. That is, the uniaxial liquid crystal molecules 310 and the biaxial liquid crystal molecules 320 lie down in a direction crossing the electric field when the electric field is applied.

As used herein, a liquid crystal molecule's orienting itself horizontally such that its axis is parallel to the plane of the substrate is referred to as a liquid crystal molecule's “lying down.”

If the liquid crystal composition included only the uniaxial liquid crystal molecules 310, the uniaxial liquid crystal molecules 310 would lie down in different directions instead of being uniformly aligned with the electric field that is applied. That is, the liquid crystal molecules lie down not only in the X-axis direction but also in other directions including the Y-axis direction. If the uniaxial liquid crystal molecules 310 lie down irregularly in this manner, the uniaxial liquid crystal molecules collide with each other, thereby generating one or more singular points. Thus, a texture region will generated around the singular point. The “texture region” is a region where the orientations of liquid crystal molecules 310 are not controlled. Therefore, light transmittance of the liquid crystal composition deteriorates, and response speed of the liquid crystal molecules 310 is also reduced.

Since the uniaxial liquid crystal molecules 310 are mixed with the biaxial liquid crystal molecules 320 in the liquid crystal composition, the uniaxial liquid crystal molecules 310 lie down in a direction that is limited according to movement of the biaxial liquid crystal molecules 320. Since the biaxial liquid crystal molecules 320 have alignment axes in two directions, the biaxial liquid crystal molecules 320 lie down comparatively regularly in a uniform direction (X-axis direction) when an electric field is applied. Also, the uniaxial liquid crystal molecules 310 have uniform movements along the biaxial liquid crystal molecules 320. Therefore, it is possible to reduce the generation of a singular point caused by the collision and the interference between the liquid crystal molecules 310 and 320. Although a singular point may be generated, it is likely to have a weak intensity. Hence, the texture region that is formed as a result is comparatively small.

Therefore, light transmittance of the liquid crystal composition is improved, and the response speed of the liquid crystal molecules 310 and 320 is also improved.

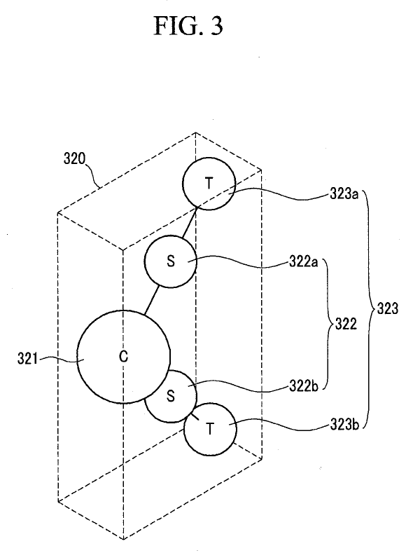

A structure of biaxial liquid crystal molecule 320 will be described with reference to FIG. 3.

As shown in FIG. 3, the biaxial liquid crystal molecule 320 includes a central functional group 321, a pair of side functional groups 322 connected to the central functional group 321, and a pair of end functional groups 323 connected to the pair of side functional groups 322, respectively. That is, a first side functional group 322a and a second side functional group 322b are connected to different sides of one central functional group 321, respectively. Then, the first side functional group 322a is connected to a first end functional group 323a, and the second side functional group 322b is connected to a second end functional group 323b.

The biaxial liquid crystal molecule 320 has a central functional group that is substantially shaped like a boomerang or a banana and moves like a plate-shaped structure as shown in FIG. 3. Therefore, the biaxial liquid crystal molecule 320 has alignment axes in two directions (Z-axis and X-axis directions).

The central functional group 321 of each liquid crystal molecule 320 includes a structure expressed by one of Chemical Structures 1 to 3.

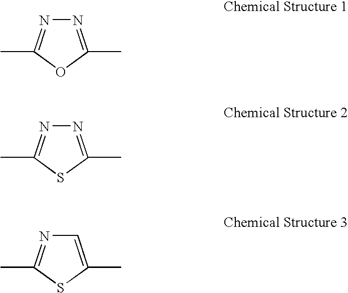

Also, the side functional group 322 of the biaxial liquid crystal molecule 320 includes a structure expressed by one of Chemical Structures 4 to 8.

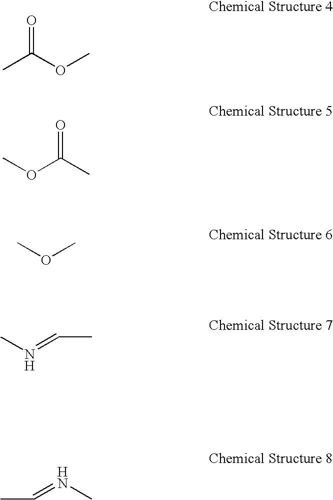

Here, it is not necessary to form the side functional groups 322 symmetrically with respect to the central functional group 321. That is, the first side functional group 322a connected to one side of the central functional group 321 may have a different structure from that included in the second side functional group 322b connected to the other side of the central functional group 321. In some embodiments, the two side functional groups 322 will be symmetrically arranged with respect to the central function group 321. Each of the two side functional groups 322, however, includes one of the structures shown in Chemical Structures 4-8. In some embodiments, at least one of the two side functional groups 322 includes one of the structures shown in Chemical Structures 4-8.

The end functional group 323 of the biaxial liquid crystal molecule 320 includes a structure expressed by one of Chemical Structures 9 to 12.

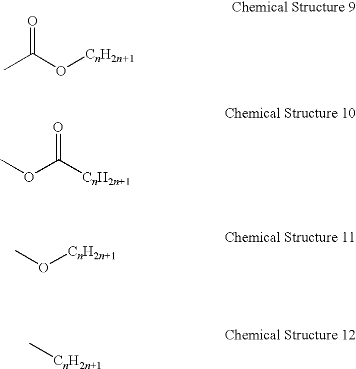

Here, n is an integer from 2 to 20. While the end functional groups 323 may be symmetrically arranged with respect to the central functional group 321, such symmetry is not necessary. Depending on the embodiment, the first end functional group 323a connected to the first side functional group 322a may include a structure identical to or different from that in the second end functional group 323b connected to the second side functional group 322b. However, each of the end functional groups 323 includes one of the structures shown in Chemical Structures 9-12. In some embodiments, at least one of the end functional group 323 includes one of the structures shown in Chemical Structures 9-12.

Also, various vertically aligned liquid crystal molecules, which are well-known to those skilled in the art, may be used as the uniaxial liquid crystal molecules 310.

Due to the structure of the liquid crystal composition, the generation of a singular point is reduced by minimizing the collision between liquid crystal molecules, and the intensity of the generated singular point is also reduced. Therefore, the liquid crystal composition may have improved light transmittance. Furthermore, the liquid crystal molecules may have improved response speed.

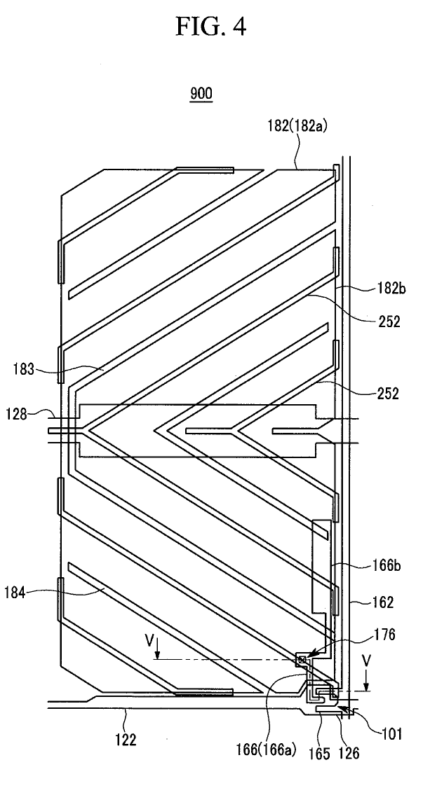

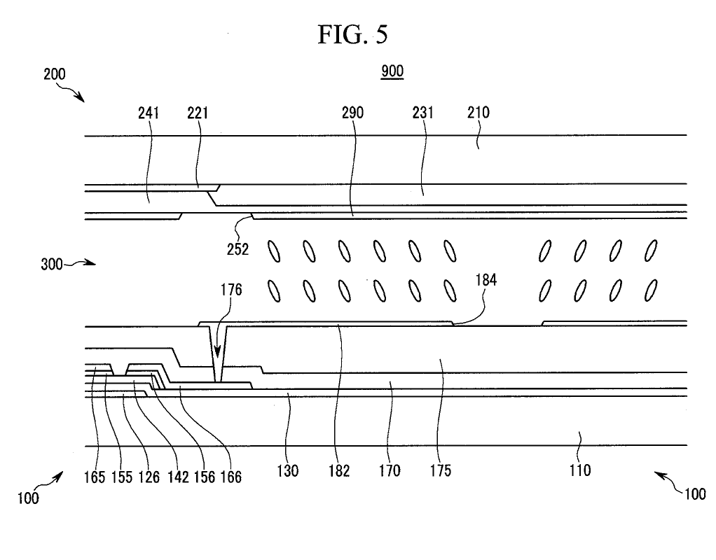

A display device 900 according to an exemplary embodiment of the present invention will be described with reference to FIG. 4 and FIG. 5. Here, the display device 900 includes the above-described liquid crystal composition. FIG. 4 is a layout view of a display device according to an exemplary embodiment of the present invention, and FIG. 5 is a cross-sectional view of FIG. 4 taken along the line V-V.

As shown in FIG. 4 and FIG. 5, the display device 900 includes a first substrate 100, a second substrate 200 facing the first substrate 100, and a liquid crystal layer 300 interposed between the substrates 100 and 200 and formed of the liquid crystal composition. Here, the first substrate 100 includes a first electrode 182, and the second substrate 200 includes a second electrode 290. Hereinafter, the first electrode 182 is referred as a pixel electrode, and the second electrode 290 is referred as a common electrode.

First, the structure of the first substrate 100 will be described.

A gate wire is formed on a first substrate member 110. The gate wire may be a single metal layer or multiple metal layers. The gate wire includes a gate line 122, a gate electrode 126, and a storage capacitance line 128. The gate line 122 extends in a horizontal direction with respect to FIG. 4, and the gate electrode 126 is connected to the gate line 122. The storage capacitance line 128 is partially overlapped with the pixel electrode 182, thereby forming storage capacitance. The storage capacitance line 128 passes the center of a pixel and extends parallel to the gate line 122.

A gate insulating layer 130 covers the gate wire on the first substrate member 110. The gate insulating layer 130 is made of an inorganic material such as silicon nitride (SiNx).

A semiconductor layer 142 is formed on the gate insulating layer 130 of the gate electrode 126. The semiconductor layer 142 is composed of a semiconductor such as amorphous silicon. Ohmic contact layers 155 and 156 are formed on the semiconductor layer 142. The ohmic contact layers 155 and 156 are made of a predetermined material such as silicide or n+hydrogen amorphous silicon doped with an n-type impurity at a high concentration. The ohmic contact layers 155 and 156 are removed from a channel between the source electrode 165 and the drain electrode 166.

A data wire is formed on the ohmic contact layers 155 and 156. The data wire may also be a single metal layer or multiple metal layers. The data wire includes a data line 162, a source electrode 165, and a drain electrode 166. The data line 162 is formed in a vertical direction crossing the gate line 122, thereby forming a pixel. The source electrode 165 is a branch of the data line 162 and extends to an upper portion of the ohmic contact layers 155. The drain electrode 166 is separated from the source electrode 165 and is formed on an ohmic contact layer 156 that is formed at the opposite side of the source electrode 165.

The drain electrode 166 includes a first drain electrode 166a and a second drain electrode 166b. The first drain electrode 166a directly applies an electric signal to a first pixel electrode 182a and is connected to the first pixel electrode 182a. The second drain electrode 166b extends from the first drain electrode 166a and is positioned under a second pixel electrode 182b. The second drain electrode 166b forms a coupling capacitance at a passivation layer 170 with the second pixel electrode 182b.

The passivation layer 170 that is made of an inorganic material such as silicon nitride (SiNx) is formed on the data wire and the semiconductor layer 142 not covered by the data wire. An organic layer 175 is formed on the passivation layer 170. The organic layer 175 is comparatively thicker than the gate insulating layer 130 and the passivation layer 170. The organic layer 175 may be formed through spin coating, slit coating, or screen printing. The organic layer 175 may be one of a benzocyclobutene (BCB) group, an olefin group, an acrylic resin group, a polyimide group, and a fluorine resin.

Since the organic layer 175 is comparatively thick, the organic layer 175 increases the distance between the data line 162 and the pixel electrode 182, thereby reducing the capacitance between the data line 162 and the pixel electrode 182. Accordingly, it allows the pixel electrode 182 to be formed close to the data line 162 or even partially overlap the data line 162, thereby increasing the aperture ratio. The organic layer 175 further suppresses capacitance buildup between the data line 162 and the pixel electrode 182 because the dielectric constant of the organic layer 175 is low.

A contact hole 176 is formed at the passivation layer 170 and the organic layer 175 to expose the drain electrode 166. The passivation layer 170 and the organic layer 175 on the storage capacitance line 128 are removed. The passivation layer 170 and the organic layer 175 are removed to easily form storage capacitance by decreasing a distance between the storage capacitance line 128 and the pixel electrode 182.

In another exemplary embodiment, the passivation layer 170 on the storage capacitance line 128 may be partially or wholly removed.

A pixel electrode 182 is formed on the organic layer 175. The pixel electrode 182 may be composed of a transparent conductive material such as indium tin oxide (ITO) or indium zinc oxide (IZO). Overall, the pixel electrode 182 is symmetrical top-to-bottom.

The pixel electrode 182 includes a first pixel electrode 182a and a second pixel electrode 182b, which are separated by a pixel electrode separation pattern 183. The second pixel electrode 182b is trapezoidal, and three sides thereof are surrounded by the first pixel electrode 182a. The pixel electrode separation pattern 183 and a pixel electrode incision pattern 184 are formed on the first pixel electrode 182a and the second pixel electrode 182b, respectively.

The first pixel electrode 182a is directly connected to the first drain electrode 166a through the contact hole 176. The second pixel electrode 182b and the second drain electrode 166b form a coupling capacitance Ccp, and the second pixel electrode 182b is indirectly connected to the second drain electrode 166b through the coupling capacitance Ccp.

The pixel electrode separation pattern 183 and the pixel electrode incision pattern 184 divide the liquid crystal layer 300 into a plurality of sub-domains with a common electrode incision pattern 252. The sub-domain is a region surrounded by patterns 183, 184, and 252, and extends in an oblique direction with respect to the gate line 122.

Hereinafter, a structure of the second substrate 200 will be described.

A light blocking member 221 is formed on a second substrate member 210. The light blocking member 221 generally sections a red filter, a green filter, and a blue filter, and blocks light to a thin film transistor 101 on the first substrate 100. The light blocking member 221 is generally made of a photosensitive organic material with a black color pigment added thereto. Carbon black or titanium oxide may be used as the black color pigment.

A color filter 231 is formed by repeating the red filter, the green filter, and the blue filter with the light blocking member 221 as a boundary. The color filter 231 applies color to light passing through the liquid crystal layer 300 and radiated from a backlight assembly (not shown). The color filter 231 is made of a typical photosensitive organic material.

An overcoat layer 241 is formed on the color filter and the light blocking member 221 where they are not covered by the color filter 231. The overcoat layer 241 protects the color filter 231 while creating a flat surface. In general, an acryl-based epoxy material is widely used.

A common electrode 290 is formed on the overcoat layer 241. The common electrode 290 may be composed of a transparent conductive material such as indium tin oxide (ITO) or indium zinc oxide (IZO). The common electrode 290 directly applies a voltage to the liquid crystal composition of the liquid crystal layer 300 with the pixel electrode 182 of the first substrate.

A common electrode incision pattern 252 is formed at the common electrode 290. The common electrode incision pattern 252 is formed in parallel with the pixel electrode separation pattern 183 and the pixel electrode incision pattern 184.

However, these patterns 183, 184, and 252 are not limited thereto. These patterns 182, 184, and 252 may be formed in various shapes.

The liquid crystal layer 300 filled with liquid crystal composition is interposed between the first substrate 100 and the second substrate 200. The liquid crystal composition includes uniaxial liquid crystal molecules and biaxial liquid crystal molecules. The display device 900 is a vertically aligned (VA) mode display, and the liquid crystal molecules are vertically aligned in a direction that is non-parallel (e.g., perpendicular) to a surface of the substrates 100 and 200 when an electric field is not applied. The liquid crystal molecules have a negative dielectric constant, and are aligned in a horizontal state when an electric field is applied. That is, the liquid crystal molecules lie down in a horizontal direction because the dielectric anisotropy is negative if an electric field is applied. Therefore, the horizontally aligned liquid crystal molecules transmit light by double refraction.

If an electric field is applied as described above, the liquid crystal molecules lie down in a uniform direction along a fringe field generated by the pixel electrode separation pattern 183, the pixel electrode incision pattern 184, and the common electrode incision pattern 252. Therefore, the liquid crystal molecules are not aligned irregularly in various directions.

Also, it is possible to maximally suppress the generation of singular points because the display device according to the present embodiment uses the liquid crystal composition having the uniaxial liquid crystal molecules and the biaxial liquid crystal molecules. As described above, the singular points are generated by collision of liquid crystal molecules that lie down irregularly because the liquid crystal molecules are not controlled by incision patterns. That is, since the uniaxial liquid crystal molecules lie down in limited directions according to movement of the biaxial liquid crystal molecules, the generation of singular points can be suppressed. Since the biaxial liquid crystal molecules have alignment axes in two directions, the biaxial liquid crystal molecules lie down in a comparative uniform direction when an electric field is applied. The uniaxial liquid crystal molecules mixed with the biaxial liquid crystal molecules have regular movement according to the biaxial liquid crystal molecules. Accordingly, it is possible to significantly suppress collision and interference between liquid crystal molecules. Also, the singular point has comparatively low intensity even though it is generated. That is, comparatively small texture region is formed.

Due to the described structure, the display device 900 has improved light transmittance and suppresses image quality deterioration. Since the display device 900 includes liquid crystal molecules having improved response speed, display performance is also improved.

Hereinafter, the present invention will be described in deend functional group through an experimental example.

The experimental example is only for exemplarily describing the present invention, and the present invention is not limited thereto.

### Experimental Example

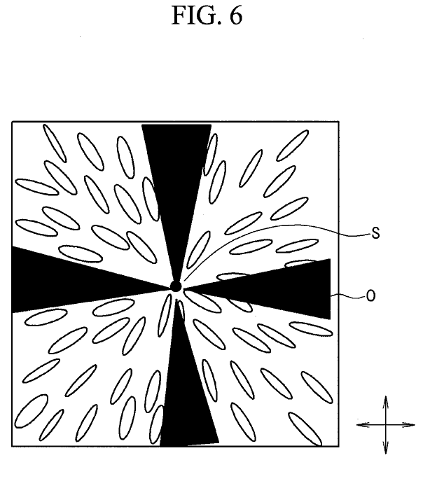

FIG. 6 shows a singular point generated in a display device using liquid crystal composition including uniaxial liquid crystal molecules and biaxial liquid crystal molecules according to an exemplary embodiment of the present invention. FIG. 6 shows distribution of liquid crystal molecules observed by cross-nicol observation. In FIG. 6, the arrows denote polarization axis directions of a polarization memory used in the display device. A mark S denotes a singular point generated by collision and interference between the liquid crystal molecules and a mark O denotes a region where texture region is generated around the singular point.

### Comparative Example

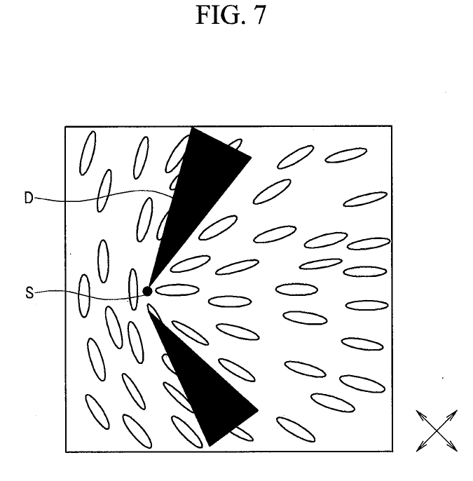

FIG. 7 shows singular points generated in a display device using liquid crystal composition having uniaxial liquid crystal molecules and biaxial liquid crystal molecules according to a comparative example. FIG. 7 shows distribution of liquid crystal molecules observed by cross-nicol observation. In FIG. 7, the arrows denote polarization axis directions of a polarization member used in the display device. A mark S denotes a singular point generated by collision and interference between liquid crystal molecules and a referential mark D is a region where texture region is generated around the singular point.

Referring to FIG. 6 and FIG. 7, not only the generation of singular point but also the generation of the texture region around the singular point are more suppressed in the liquid crystal composition of the experimental example than that of the comparative example.

The experiment clearly shows that the singular points generated by collision between the liquid crystal molecules are reduced and the intensity of the generated singular point is also reduced in the display device according to an exemplary embodiment of the present invention.

The liquid crystal composition according to the present invention reduces collision between the liquid crystal molecules so as to reduce generation of singular points. Also, the intensity of the generated singular point is reduced. Therefore, the liquid crystal composition may have improved light transmittance.

The display device according to the present invention improves light transmittance and reduces image quality deterioration by using the liquid crystal composition described above.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal composition comprising:
uniaxial liquid crystal molecules; and
biaxial liquid crystal molecules mixed with the uniaxial liquid crystal molecules for controlling an alignment direction of the uniaxial liquid crystal molecules.

2. The liquid crystal composition of claim 1, wherein each biaxial liquid crystal molecule includes a central functional group, a pair of side functional groups connected to the central functional group, and a pair of end functional groups connected to the pair of side functional groups, respectively.

3. The liquid crystal composition of claim 2, wherein the central functional group includes at least one of the structures expressed by Chemical Structures 1 to 3:

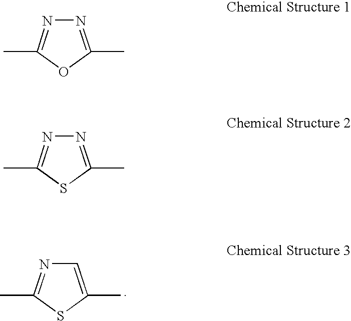

4. The liquid crystal composition of claim 2, wherein at least one of the side functional groups includes at least one of the structures expressed by following Chemical Structures 4 to 8:

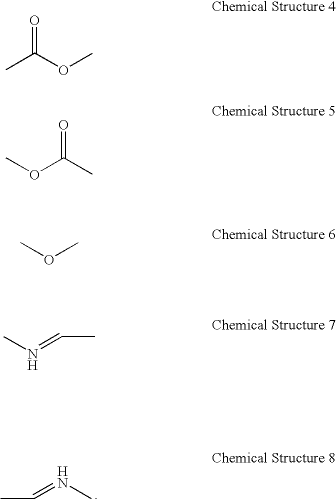

5. The liquid crystal composition of claim 4, wherein the side functional groups include the same structure selected from Chemical Structures 4-8.

6. The liquid crystal composition of claim 4, wherein the side functional groups include different structures selected from Chemical Structures 4-8.

7. The liquid crystal composition of claim 2, wherein at least one of the end functional groups includes at least one of the structures expressed by Chemical Structures 9 to 12: 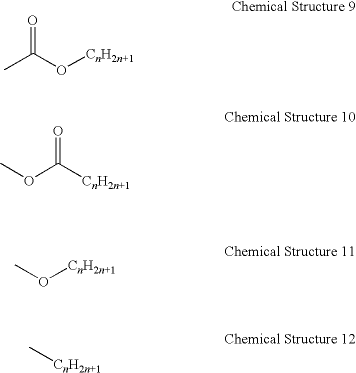
wherein n is an integer from 2 to 20.

8. The liquid crystal composition of claim 5, wherein the end functional groups include the same structure selected from Chemical Structures 9-12.

9. The liquid crystal composition of claim 5, wherein the end functional groups include different structures selected from Chemical Structures 9-12.

10. The liquid crystal composition of claim 1, wherein about 0.1 moles to about 1 mole of the biaxial liquid crystal molecules is mixed with about 1 mole of the uniaxial liquid crystal molecules.

11. A display device comprising:
a first substrate having a first electrode;
a second substrate having a second electrode; and
a liquid crystal composition having liquid crystal molecules aligned substantially orthogonally to and between the first substrate and the second substrate when an electric field is applied,
wherein the liquid crystal composition includes:
uniaxial liquid crystal molecules, and
biaxial liquid crystal molecules mixed with the uniaxial liquid crystal molecules for controlling an alignment direction of the uniaxial liquid crystal molecules.

12. The display device of claim 11, wherein incision patterns are formed at the first electrode and the second electrode, respectively.

13. The display device of claim 11, wherein each biaxial liquid crystal molecule includes a central functional group, a pair of side functional groups connected to the central functional group, and a pair of end functional groups connected to the pair of side functional groups, respectively.

14. The display device of claim 13, wherein the central functional group includes at least one of the structures expressed by Chemical Structures 1 to 3.

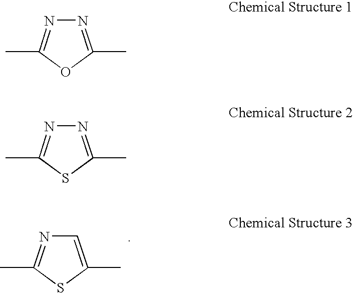

15. The display device of claim 13, wherein each of the side functional groups includes at least one of the structures expressed by the following Chemical Structures 4 to 8:

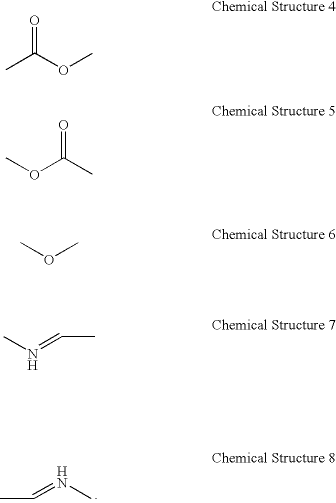

16. The liquid crystal composition of claim 15, wherein the side functional groups include the same structure selected from the Chemical Structures 4-8.

17. The liquid crystal composition of claim 15, wherein the side functional groups include different structures selected from the Chemical Structures 4-8.

18. The display device of claim 13, wherein the end functional groups include at least one of the structures expressed by Chemical Structures 9 to 12: 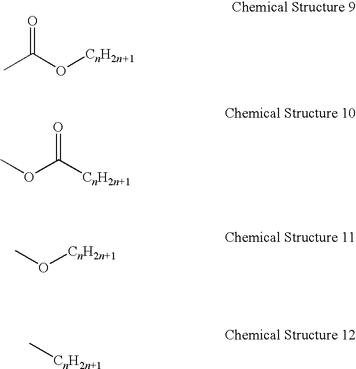
wherein n is an integer from 2 to 20.

19. The liquid crystal composition of claim 18, wherein the end functional groups include the same structure selected from Chemical Structures 9-12.

20. The liquid crystal composition of claim 18, wherein the end functional groups include different structures selected from Chemical Structures 9-12.

21. The display device of claim 7, wherein 0.1 moles to 1 mole of the biaxial liquid crystal molecules are mixed with every 1 mole of the uniaxial liquid crystal molecules.
